(19) United States
(12) Patent Application Publication
(10) Pub. No.: US 2025/0024227 A1
(43) Pub. Date: Jan. 16, 2025

(54) AUDIO SYSTEM AND METHOD FOR TRANSMITTING AN AUDIO SIGNAL

(71) Applicant: Robert Bosch GmbH, Stuttgart (DE)

(72) Inventors: Andreas Mueller, Waiblingen (DE); Johannes Von Hoyningen-Huene, Mielkendorf (DE); Rene Guillaume, Boeblingen (DE); Stephan Ludwig, Aalen-Waldhausen (DE)

(21) Appl. No.: 18/713,397

(22) PCT Filed: Nov. 28, 2022
(86) PCT No.: PCT/EP2022/083411

§ 371 Date: May 24, 2024

(30) Foreign Application Priority Data
Dec. 2, 2021 (DE) 10 2021 213 699.0

(51) Int. Cl. H04W 4/024; G06F 3/16; H04W 4/021; H04W 4/06; H04W 4/33; H04W 76/20

(52) U.S. Cl. CPC H04W 4/024; G06F 3/165; H04W 4/021; H04W 4/06; H04W 4/33; H04W 76/20

(57) ABSTRACT

A method for transmitting an audio signal from a first communication node to a second communication node using an audio system and use of mobile communications infrastructure.

### FIELD

The present invention relates to an audio system and a method for transmitting an audio signal.

### BACKGROUND INFORMATION

It is conventional to locate mobile devices via mobile networks and use these devices to output geographically targeted audio content (e.g., audio tour content).

For example, U.S. Pat. No. 9,578,621 describes providing audio tour data for mobile devices based on position data.

U.S. Patent Application Publication No. US 2012/0278721 A1 describes a museum guide system and a museum guide method.

An audio tour segment can be played by mobile devices when proximity to a specific object is detected.

U.S. Patent Application Publication No. US 2020/0314592 A1 describes a system and a method for creating, storing and providing self-guided audio tours.

The mobile device is located and used to output audio tour data.

A disadvantage is that the mobile devices 20 need to be maintained, and the batteries need to be charged. This means maintenance and care effort. In addition, the audio quality of the audio system is often poor because analog, noise-prone modulation methods are typically used for signal transmission. Compared to modern mobile devices, the receiving devices usually have very limited memory and computing resources and are therefore severely limited in their ability to be expanded with additional, possibly computationally intensive functions or services.

### SUMMARY

An advantage of the present invention is the combination of positioning a mobile device with the output of audio content via a loudspeaker integrated into the environment.

The method works independently of the actually used mobile communications standard, infrastructure hardware and mobile devices.

A method according to the present invention for transmitting an audio signal from a first communication node to a second communication node is carried out by means of an audio system and the use of mobile communications infrastructure in buildings. It is primarily a guided audio tour with a tour guide and a tour group listening to the explanations of the tour guide. The audio system maintains a connection with the mobile communications infrastructure.

According to an example embodiment of the present invention, the method comprises at least the following steps:
Registering the first communication node by means of a unique identification feature, wherein a message is sent to the audio system that the first communication node is being used for an audio tour,
Transmitting the audio signal via the first communication node to the audio system, wherein the connection to the base station of the mobile communications infrastructure must always exist,
Transmitting the audio signal via the audio system to the second communication node.

Advantageously, the transmission from the mobile device to the second communication nodes designed as loudspeakers or battery-operated terminals takes place via the audio system.

This has the advantage that an audio tour can be conducted flexibly. If loudspeakers are used instead of battery-operated terminals, material and administration costs are saved because a separate audio tour system does not need to be purchased and maintained, and the batteries of the receiving devices do not need to be constantly charged/maintained. In addition, the use of established and standardized mobile communications technology makes it possible to economically implement the present invention.

The audio signal is easier to hear because no battery-powered audio devices are used, so the battery cannot fail.

According to an example embodiment of the present invention, if it is determined which mobile communications antenna receives the audio signal from the first communication node, the audio signal can advantageously be sent to the second communication unit which is closest to this mobile communications antenna via the mobile communications antenna at which the audio signal of the first communication node is received. This has the advantage that the audio connection via the mobile communications connection has better audio quality than audio signals transmitted via analog, noise-prone modulation methods.

If there are several zones in a building and these zones are passed through by the tour groups or the tour guide, it can be advantageously determined in which zone the audio signal must be transmitted.

According to an example embodiment of the present invention, to accomplish this, there are at least the following steps:
Determining the position of the first communication node 18 located in the first zone Z1 or in the second zone Z2,
Transmitting, by the audio control system, the audio signal to the second communication node 20 located in the first zone Z1 or in the second zone Z2,
Playing back audio signals.

This has the advantage that remarks by the tour guide can be transmitted over longer distances.

Further advantageous developments can be found in the figures and the description of the figures.

### BRIEF DESCRIPTION OF THE DRAWINGS

FIG. 1 shows a building infrastructure having a building in a schematic representation, according to an example embodiment of the present invention.

FIG. 2 shows a method according to an example embodiment of the present invention for transmitting an audio signal.

FIG. 3 shows another exemplary embodiment of the present invention.

### DETAILED DESCRIPTION OF EXAMPLE EMBODIMENTS

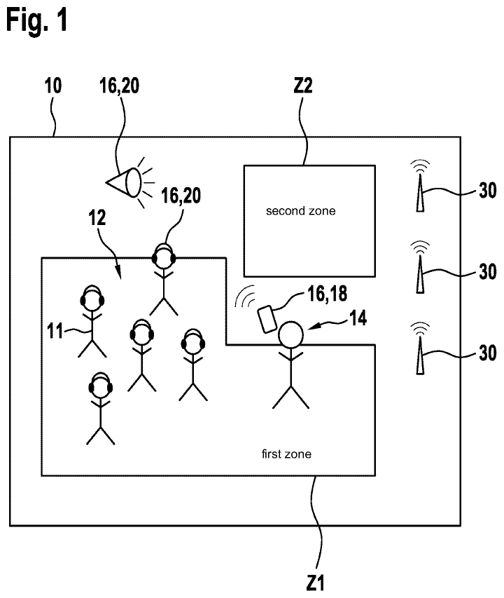

FIG. 1 shows an example of a building infrastructure having a building 10. The building 10 may be an office building, a museum, a factory or production hall, an administrative building, an educational institution or the like. There are several zones in the building, but at least a first zone Z1 and a second zone Z2.

A group 12 of visitors 11 is guided through the building 10 by a tour guide 14. However, it is also possible that the tour group 12 is guided outside the building 10 by the tour guide 14.

The tour guide 14 provides the group 12 with both explanations and safety instructions to protect the visitors 11.

Both the tour guide 14 and the group 12 of visitors 11 can be in the first zone Z1, or in the second zone Z2, or in different zones Z1, Z2. Zones Z1 and Z2 can be freely passed through and changed by the tour guide 14 and the group 12 of visitors 11.

An audio system 16 is used to guide the group 12. The audio system 16 comprises a first communication node 18 and at least one second communication node 20. The first communication node 18 is designed as a mobile device which the tour guide 14 uses. In the exemplary embodiment, the mobile device 18 is a smartphone having a microphone. However, the mobile device 18 can be any embodiment of a communication node that appears reasonable to a person skilled in the art.

In a first exemplary embodiment, the second communication node 20 is designed as a loudspeaker. Each visitor 11 is located near a loudspeaker. The “proximity of a loudspeaker” is understood here to mean a distance of a visitor 11 to a loudspeaker that enables a visitor 11 to be able to clearly hear a loudspeaker announcement and to sense the sound as neither too loud nor too quiet.

In a second exemplary embodiment, the second communication node 20 is designed as a battery-operated terminal. Each visitor 11 carries a battery-operated terminal 20.

The audio system is provided to transmit an audio signal from the first communication node 18 to the second communication node 20. In the exemplary embodiment, the audio signal from the first communication node 18 is a voice signal of the tour guide 14. The second communication node 20 reproduces the audio signal. In the first exemplary embodiment, the second communication node 20 reproduces the audio signal as a loudspeaker announcement. In the second exemplary embodiment, the second communication node 20 reproduces the audio signal, for example via headphones, to each visitor 11 of the tour group 12.

In order to transmit the audio signal from the first communication node 18 to the second communication node 20, the audio system 16 uses a mobile communications infrastructure present in the building 10. The mobile communications infrastructure comprises at least one base station. The mobile communications antennas 30 of the base station are located a short distance apart from each other. A short distance is understood here to mean a distance that is less than or equal to 10 m.

In order to make a call, the communication nodes 18, 20 must maintain the connection to the mobile communications base station 30.

The base station 30 of the 5th generation of mobile communications (5G) makes it possible to detect the smallest distance of the first communication node 18 and/or the second communication node 20 to one of the antennas 30.

Optionally, the system enables the accurate determination of the position of the communication nodes up to 0.5 m, for example by using multilateration or multiangulation methods. The position can be determined in the communication nodes or in the base station.

It is also possible for the building 10 to be equipped with a fire alarm and/or evacuation system, wherein an evacuation system includes evacuation loudspeakers at a distance of approximately 10 m. The evacuation loudspeakers can be addressed directly according to zones.

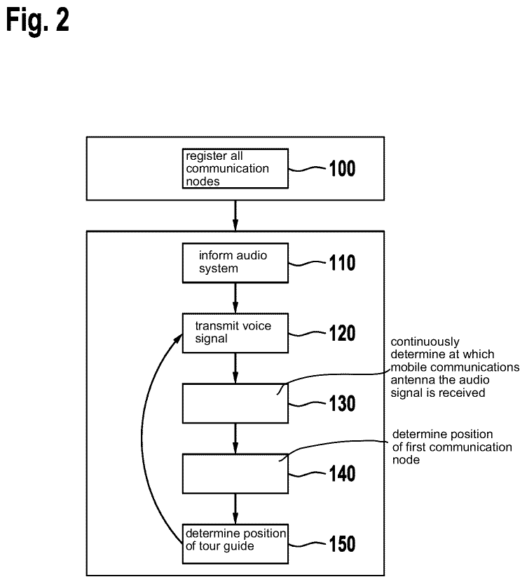

FIG. 2 shows how the existing infrastructure is used with the method described below:

In a first method step 100, the administration 50 registers all communication nodes 18 used by a tour guide 14 and stores them as legitimate users of the audio system.

At the beginning of a tour, the audio system 16 is informed in a step 110 that the first communication node 18 is being used for an audio tour.

For this purpose, a unique identification feature is registered in the system.

A unique identification feature is an identification number, an integrated circuit card identifier, an ICCID, a universal integrated circuit card, a SIM card or the like. The identification feature connects to the audio system.

Identification can also be done by selecting from a list of already known identification features.

Optionally, the second communication node 20 is registered in the audio system 16. For example, visitors 11 can register using an app via NFC at an NFC reader in the audio system 16.

In step 120, the voice signal of the tour guide 14 is transmitted via the first communication node 18 to the audio system 16. The connection to the base station of the mobile communications infrastructure must exist.

The voice signal is transmitted to the second communication node 20 via the audio system.

According to the present invention, the transmission takes place from the mobile device 18 of the tour guide to the loudspeakers 20 or to the battery-operated terminals 20 of the tour groups 12 via the audio system.

In a step 130, it is continuously determined at which mobile communications antenna 30 the audio signal of the first communication node 18 is received. The determination takes place in the base station. However, the determination can also occur in a location downstream of the base station.

Optionally, in a step 140, the position of the first communication node 18 is determined by further location mechanisms of mobile communications, e.g., multilateration or multiangulation using measured values from neighboring base station antennas.

In step 150, the position of the tour guide 14 is determined.

If the position of the tour guide 14 is known, the mobile communications antenna 30 closest thereto can be ascertained. The audio signal of the first communication unit is sent via this mobile communications antenna 30 to the second communication unit that is also closest to this mobile communications antenna 30. This allows visitors 11 to hear the voice signal of the tour guide via loudspeakers or headphones.

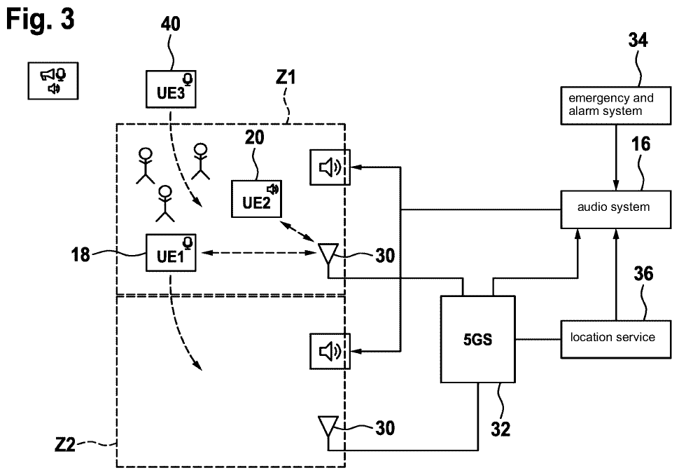

FIG. 3 shows another exemplary embodiment of the present invention. FIG. 3 shows a first zone Z1, a second zone Z2, an audio system 16, an emergency and alarm system 34, a location service 36, and a base station having mobile communications antennas 30.

A tour guide 14 and a group 12 of visitors 11 are located in the first zone Z1.

An audio system 16 is used to guide the group 12. The audio system 16 comprises a first communication node 18 and at least one second communication node 20. The first communication node 18 is designed as a mobile device which the tour guide 14 uses. In the exemplary embodiment, the mobile device 18 is a smartphone having a microphone. However, the mobile device 18 can be any embodiment of a communication node that appears reasonable to a person skilled in the art.

The first communication node 18 is registered in the audio system 16 by an identification feature. In connection with this, the first communication node 18 is assigned all necessary rights to use the audio system.

In a third exemplary embodiment, the second communication node 20 is designed as a loudspeaker. Each visitor 11 is located near a loudspeaker. The “proximity of a loudspeaker” is understood here to mean a distance of a visitor 11 to a loudspeaker that enables a visitor 11 to be able to clearly hear a loudspeaker announcement and to sense the sound as neither too loud nor too quiet.

In a fourth exemplary embodiment, the second communication node 20 is designed as a battery-operated terminal. Each visitor 11 carries a battery-operated terminal 20.

The position of the first communication node 18 is determined by the location service 36.

The audio signal of the first communication node 18 is forwarded from the base station to the audio system 16. The following steps are necessary:
Determining the position of the first communication node 18 located in the first zone Z1,
Transmitting, by the audio control system, the audio signal to the second communication node 20 also located in the first zone Z1,
Playing back audio signals.

Now the tour guide 14 with the first communication node 18 and the tour group 12 with the second communication node 20 move into the second zone Z2.

The location service 36 locates the first communication node in the second zone Z2. As soon as the first communication node 18 is located in the second zone Z2, the audio system 16 forwards the audio signals to the second communication node 20 in the second zone Z2.

There are also possible expansions of the basic procedure: By using their own mobile devices, a visitor can access additional services. This can, for example, include a simultaneous translation function that runs either locally on personal devices or centrally on 5GS components.

Furthermore, the audio system 16 can have a prioritization function. The prioritization function monitors and allows the forwarding of audio signals according to a predefined priority.

Example: Only audio signals from the first communication node 18 are forwarded as long as no higher priority audio signals from the emergency and alarm system are sent.

If the emergency and alarm system 24 sends an audio signal, the forwarding of the audio signal from the first communication node 18 is stopped by the audio control system.

Furthermore, a second tour group 40 can enter the first zone Z1. However, the first zone Z1 is still used by the first tour group 12.

The prioritization function ensures that the different audio signals of the two groups are not superimposed, and that the audio output in the first zone Z1 can only be used by the second tour group 40 once the first tour group 12 has left the first zone Z1.

For a latency-optimized output of the audio signals, the audio system can be implemented in a distributed manner. For this purpose, essential latency-critical subfunctions can be implemented multiple times and locally, i.e., physically close to the desired zone, e.g., on edge servers. For example, zones 1 and 2 can have their own 5G access networks that forward the audio data to a local audio subsystem with low latency. This means that additional zones can have their own mobile communications access networks and audio subsystems that can be interconnected and coordinated via a common infrastructure.

1-10. (canceled)

11. A building infrastructure comprising a building and having at least a first zone and a second zone, wherein a group of visitors is guided through the building by a tour guide, and wherein the tour guide and the tour group can be in any of: (i) the first zone, (ii) the second zone, and (iii) in different zones of the first and second zones, and the first and second zones can be freely passed through and changed, wherein an audio system is used to guide the tour group, wherein the audio system has at least one first communication node and at least one second communication node.

12. The building infrastructure according to claim 11, wherein the first communication node is a mobile device, and the second communication node is a loudspeaker or a battery-operated terminal.

13. The building infrastructure according to claim 11, wherein the audio system is provided to transmit an audio signal from the first communication node to the second communication node using a mobile communications infrastructure present in the building, wherein the audio signal from the first communication node is a voice signal from the tour guide.

14. The building infrastructure according to claim 13, wherein the mobile communications infrastructure includes at least one base station, and mobile communications antennas of the base station are arranged at a distance from one another which is less than or equal to 10 meters.

15. A building infrastructure comprising a building, and a first zone, a second zone, an audio system, an emergency and alarm system, a location service, and a base station having mobile communications antennas.

16. A method for transmitting an audio signal from a first communication node to a second communication node using an audio system, and a mobile communications infrastructure, wherein the audio system maintains a connection with the mobile communications infrastructure, the method comprising the following steps:
registering the first communication node using a unique identification feature, wherein a message is sent to the audio system that the first communication node is being used for an audio tour;
transmitting the audio signal via the first communication node to the audio system, wherein a connection to a base station of the mobile communications infrastructure must always exist; and
transmitting the audio signal via the audio system to the second communication node.

17. The method according to claim 16, wherein the second communication node includes a plurality of second communication nodes including a plurality of loudspeakers or battery-operated terminal, and wherein the transmission from the mobile device to the loudspeakers or battery-operated terminals takes place via the audio system.

18. The method according to claim 17, further comprising determining at which mobile communications antenna the audio signal of the first communication node is received, wherein the determination is made in the base station.

19. The method according to claim 18, wherein the audio signal of the first communication unit is sent to the second communication unit which is closest to the mobile communications antenna via the mobile communications antenna at which the audio signal of the first communication node is received.

20. A method for transmitting an audio signal from a first communication node in a first zone or a second zone to a second communication node in the first zone or the second zone using an audio system and a mobile communications infrastructure, wherein the audio system maintains a connection with the mobile infrastructure, the method comprising the following steps:
determining a position of the first communication node located in the first zone or in the second zone;
transmitting, by the audio control system, the audio signal to the second communication node located in the first zone or in the second zone; and
playing back the audio signals.
